(19) United States
(12) Patent Application Publication
(10) Pub. No.: US 2009/0297671 A1
(43) Pub. Date: Dec. 3, 2009

(54) Infusion Method for Vacuum Fried Fruit Leveraging

(75) Inventors: Varadharajan Radhamani BASKER, Plano, TX (US); Vamshidhar PUPPALA, McKinney, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 12/131,609

(22) Filed: Jun. 2, 2008

(51) Int. Cl. A23B 7/022

(52) U.S. Cl. 426/102; 426/506; 426/465; 426/640; 426/281; 426/89; 426/648

(57) ABSTRACT

A method for infusing fruits and vegetables with prebiotic soluble fibers in the form of either short chain fructooligosaccharides or dextrins. Fruits and vegetables are submerged in an infusion solution of prebiotic soluble fiber, and undergo both atmospheric and vacuum infusion processes. The infusion solution is maintained at a temperature of between about 45° F. to about 50° F. and at a Brix of about 30° to about 60°. Vacuum (low pressure) pulses are applied to the product to expedite solids infusion (mass transfer) and thereby decrease infusion time and the product is subsequently vacuum fried to attain a great-tasting, fiber-enriched and aesthetically-pleasing fruit or vegetable product with reduced sweetness, good texture, and an enhanced natural taste with less than 2% moisture by weight and a significantly long shelf-life of up to 12 months.

### BACKGROUND OF THE INVENTION

1. Technical Field

The present invention relates to an improved method for the infusion of vacuum fried fruits. The method involves the infusion of pre-biotic soluble fibers, into the intercellular matrix of fruits and vegetables, such as apple slices, pineapple tidbits, carrot slices, and whole green beans, as an alternative to the traditional infusion of sugars, in the form of glucose, maltose, and sucrose or corn syrups.

2. Description of Related Art

Fruits and vegetables are an important part of any good diet. Eating fruits and vegetables can help ward off heart disease and stroke, control blood pressure and cholesterol, and avoid painful intestinal ailments. As snack foods, they provide many beneficial nutrients such as vitamins, minerals, fiber, and antioxidants with few calories. However, fruits and vegetables perish fairly quickly and thus several methods have been developed to prolong their shelf-life.

One such method of prolonging the shelf-life of a fruit or vegetable is by freezing. Extreme cold simply retards growth of microorganisms and slows down changes that affect quality or cause spoilage in food. Properly frozen fruits will retain much of their fresh flavor and nutritive value; however, they must be thawed out prior to subsequent processing. Traditional methods of thawing frozen fruits and vegetables require heat treatment in the form of hot water or steam, for example, which can negatively impact texture, flavor, and the appearance of the fruit or vegetable as well as its nutrient content.

Another common method of prolonging the shelf-life of a fruit or vegetable is dehydration, or the removal of water to prevent the growth of microorganisms and decay. There are many different methods for dehydrating food products, each with their own advantages to achieve desired end product characteristics. Frying is a common dehydration and cooking process involving beat application, used in the production of different types of food, including a wide variety of commercial, shelf-stable snacks that are low in moisture content and have a crispy texture. Processing fruits and vegetables, which are typically low in solids and high in moisture content, using frying as the dehydration process requires elevation of their solids content prior to frying. If fried without being infused with incremental solids, fruits and vegetables will result in products with unacceptable quality in terms of appearance (shrunken, dark), texture (dense, tough, chewy), and oil content (usually high). Solids are infused into fruits and vegetable pieces by immersing them in a hypertonic solution, i.e., a solution with a higher concentration of solids than in the fruit or vegetable. This concentration difference results in two mutually counter flows—solids from the infusion solution entering the fruit or vegetable tissue (solids infusion) and water traveling out of the fruit or vegetable tissue (osmotic dehydration). The addition of solids to the fruit and vegetable pieces strengthens the body structure of the pieces and prevents collapse of the cell wall structure due to the release of the turgor pressure during post-infusion dehydration. Further, the addition of solids prior to subsequent processing develops a shelf stable intermediate and/or finished product with an appealing texture.

Well known methods exist in the art for infusion of fruit and vegetable pieces. These methods employ varying ingredients, such as corn syrups that are rich in sugars, to incorporate sugar and higher saccharide solids into fruits and vegetables due to the cost and supply advantages of solutions containing mono-, di-, tri- and polysaccharides. The resulting product retains the appearance of the original fruit and vegetable pieces. However, this also results in finished fruit and vegetable products with high amounts of sugar, increasing the amount of caloric density at the expense of nutrient density.

Many solutes may be employed in the infusion process; however, not all solutes will provide an end product that is aesthetically pleasing with positive effects on flavor. Sugars can be too sweet, especially in vegetables or fruits that are already sweet in raw product form. Further, unclarified brown rice syrup and tapioca syrup solutes, for example, result in a color darker than the original fruit or vegetable product, while evaporated cane juice, brown sugar and apple juice result in a darker product as well as one with increased sweetness, which some consumers may not desire. Further, some fibers may leave a consumer with an unwanted bitter aftertaste.

Given the growing interest in “prebiotics”, defined as “a non-digestible food carbohydrates that beneficially affect the host by selectively stimulating the growth and/or the activity of one or a limited number of beneficial bacterial species in the colon (also known as probiotics),” it has been shown that adding soluble fiber to the diet in humans at doses from 4 to 12.5 grams per day leads to an increase in gastrointestinal health.

An alternative solute that has been utilized in the infusion process is seen in U.S. Pat. No. 7,118,772 to Froseth et al. This method infuses fruits with inulin of a particular molecular weight at 40 degrees Celsius to provide a shelf-stable product with reduced water activity and high levels of fiber. However, this method requires an infusion time of up to 24 hours and is applicable mostly to fruits. In addition, inulin breaks down into fructose at pH levels less than 3.0 and some types of inulin form a gel during dissolution. Moreover, the method results in a product having a higher moisture content and consequently, a less stable food product with a shorter shelf-life. Further, the inulin solution may be mixed with glycerin, and this has been associated with some off-flavors, bitterness and soft-textured end products, which is not always desirable. Finally, inulin contains longer chains of oligofructose that remain in the body for longer periods of time, which can cause unwanted gastrointestinal discomfort.

Accordingly, as an alternative to using sugars in general, and corn syrup in particular, as ingredients in processed foods, it is desirable to have an improved method for infusing both fruits and vegetables with an ingredient that will provide the same functional benefits of sugars while enhancing product nutrition and the natural flavor of the fruit, as well as minimizing unwanted sweetness. It is also desirable to produce such product with improved appearance, taste, and texture. It is also advantageous to provide an infusion method which can increase the nutritional value and shelf-life of fruit and vegetable products. Further, it is desirable to provide a method which allows for the control of the amount of fiber; such that more than the recommended amount of daily fiber is not consumed and gastrointestinal discomfort is avoided. Finally, it is desirable to create such a product within a shorter period of time to allow for decreased operating and capital expenses and increased throughput.

### SUMMARY OF THE INVENTION

The present invention provides a method for the infusion of both fruits and vegetables with a solution comprising pre-biotic soluble fibers in the form of either fructooligosaccharides or dextrins for the production of vacuum fried fruit and vegetable snacks. Short chain fructooligosaccharides used by the applicants provide the same functional benefits as sugars or corn syrups in processed fruits and vegetables. Dextrins used by applicants are corn or wheat-based soluble fibers, highly soluble and highly stable to use in food processes. Consequently, these soluble fibers can be used as an effective substitute for corn syrup for the infusion into the intercellular matrix of fruits and vegetables, such as apple slices, pineapple tidbits, carrot slices and whole green beans, to provide for a longer shelf-life. The soluble fibers used by applicant further contribute 1.5 to 2 calories/g compared to 4 calories/g for simple sugars and other carbohydrates in corn syrup. Thus it is also a low calorie substitute that provides additional nutritious benefits.

Following infusion, the products undergo atmospheric and vacuum infusion and are thereafter vacuum-fried to create a fried food product. Apple slices (of but not limited to Empire variety apples) are successfully infused with soluble fibers resulting in products similar to those made with high-maltose corn syrup in terms of amount of infused solids, appearance, texture, and oil content. However, the end product is significantly less sweet and contains significantly more fiber and natural flavor with fewer calories and a longer shelf-life. Whole green beans, carrot chips, and pineapple snacks are also produced successfully by infusing frozen whole green beans, carrot slices, and pineapple tidbits with solutions of soluble fibers. All end products contain an excellent source of fiber, between 9 to 12 grams of fiber per ounce, of which 8 to 10 grams is added via infusion of the soluble fiber, and less than 2% moisture by weight.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart representation depicting the overall process of one embodiment of the invention.

### DETAILED DESCRIPTION

Using the method and solutes of the present invention, fruit or vegetable products undergo a combination of atmospheric and vacuum infusion with solutions comprised of prebiotic soluble fibers prior to subsequent vacuum-frying. The raw fruit or vegetable product used may be fresh or partially frozen depending on availability and the desired amount of fiber in the end product. One skilled in the art will appreciate that the present method can be used to combine the present solute with any other suitable solute to deliver targeted amounts of fiber in the processed fruit or vegetable end product. Examples of fruit or vegetable pieces that may be used include, but are not limited to, apple slices (of any variety), pineapple tidbits/chunks/cubes, carrot slices, whole green beans, banana slices, bell peppers, blueberries, broccoli, cherries, carrots, cauliflower, corn, cucumber, grapes, Jack fruit, kiwi, lychee, mango, melons, onion, peaches, pears, peas, potatoes, pumpkin, raspberries, strawberries, squash, taro, sweet potato, and zucchini.

Both soluble and insoluble types of fiber are present in all plant foods, with varying degrees of each according to a plant's characteristics. Fructans are a class of soluble fibers comprised of polymers of fructose molecules and are generally commercially available as oligofructose or fructooligosaccharides. These two subclasses of fructans differ in their source and composition; thus, are broken down differently during processing and digestion. Polymers with identical composition but different total molecular weights exhibit different physical properties. For example, short chain fructooligosaccharides (scFOS) generally have a sweet taste, whereas longer fructan chains, such as Inulin, have a neutral taste and tend to form emulsions with a fat-like texture. ScFOS are characterized by relatively short chains of monosaccharide molecules linked together by bonds that are resistant to digestion to human digestive enzymes. NutraFlora® from GTC Nutrition, LLC (Colorado) is a commercially branded scFOS fiber ingredient derived from beet or cane sugar using a traditional natural fermentation method, resulting in a short chain fructooligosaccharide with an average degree of polymerization (DP) of 4. DP corresponds to the number of monomer units making up the polymer fiber chain and is a measure of molecular weight and size, which depends upon several factors: chief among them being the plant source for the fiber and processing conditions. Like other fibers, dextrins are a group of carbohydrates not digestible in the upper digestive tract. Produced by the hydrolysis of starch, they are mixtures of linear α-(1,4)-linked D-glucose polymers starting with an α-(1,6) bond. They have the same general formula as carbohydrates but are of shorter chain length with a generally neutral, non-sweet taste. Dextrins are available under the trade name Nutriose® manufactured by Roquette and derived from partially hydrolyzed starch by heating in the presence of food-grade acid, resulting in a molecular weight of approximately 5,000 Da.

Both fructooligosaccharides and dextrins are prebiotic fibers proven to improve digestive function and regularity by promoting growth of beneficial probiotic microflora in the large intestine and the absorption of minerals, especially calcium and magnesium, while supporting a strong immune system. Prebiotic fibers escape digestion in the small intestine and pass through most of the digestive tract until they reach the large intestine, where they are fermented by the probiotic bacteria such as Bifidobacteria and Lactobacilli of the colon into short-chain fatty acids (SCFA) in the intestine. The SCFA promote conditions in the gut (lower pH) that enhance retention and absorption of essential mineral nutrients such as calcium and magnesium, enhance immunity by inhibiting growth of harmful pathogens, and improve normal bowel functions. In one preferred embodiment, food products are infused with scFOS because the short-chain structure enables it to be utilized more quickly by the probiotic bacteria in the digestive tract than other prebiotics, such as inulin, which contains longer-chain structures. Longer-chain prebiotic structures may take up to 12 hours to be broken down, remaining in the digestive system longer and causing uncomfortable gas and bloating. Without being limited by theory, it is believed that the similar average molecular weight of the fructooligosaccharides and corn syrup (high-maltose) (627 vs. 651) helps to provide the same functional benefits in the infusion process.

Further, the solution is only 30% as sweet as sugar and only 25% as sweet as fructose and provides many positive functional benefits including adding fiber, enriching flavors, improving moistness, lowering carbohydrate content, and increasing the shelf-life of products. In another preferred embodiment, food products are infused with dextrin because of its miscible nature, enabling it to mix well with other infusion solutes, and high fiber content. Further, its lack of flavor, sweetness, or odor provides the same positive functional benefits as short chain fructooligosaccharides, including but not limited to enriching the natural flavors in food products, adding fiber and increasing the shelf-life.

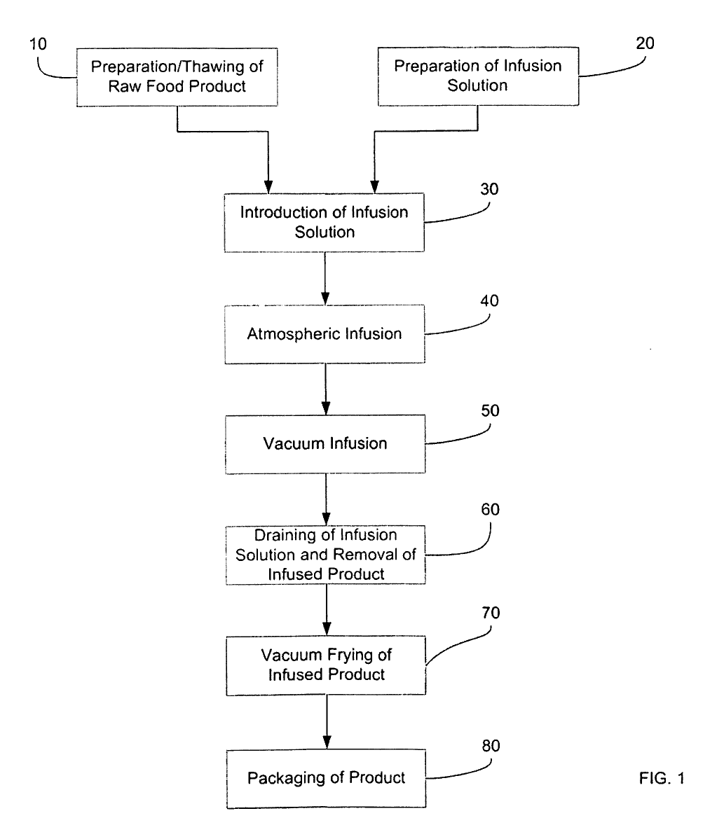

One embodiment of the invention utilizing fresh food product is described in FIG. 1. Raw product, including fresh or frozen fruit and vegetable products, is processed 10 prior to transfer to a mixing apparatus, such transfer occurring by any means known in the art, such as a conveyor, or even manually. As used herein “frozen” refers to a product which is at least partially frozen or comprises at least some frozen moisture. Thus, the term encompasses product which is either partially or fully frozen. Virtually any fruit or vegetable can comprise the frozen product so long as the fruit and vegetable is capable of being infused with solids without substantial damage to the internal cellular structure. In some embodiments the partially frozen product comprises individually quick frozen (IQF) product. While the embodiments described refer generally to IQF product, it should be noted that the invention is not so limited as it applies to any frozen product. As used herein the terms “IQF product” shall refer to any fruit or vegetable product which is stored as an IQF product and can be infused with solids. IQF product can have a temperature from about −10° F. to less than about 32° F., but they are typically kept at temperatures of about −10° to about 10° F.

The processing of step 10 may include washing, coring, pitting, cutting, slicing, thawing, and other steps prior to infusion as required by the specific product. Consequently, the processing 10 of the food products will differ depending on the fruit or vegetable chosen. The size of the batch of product processed depends on the size of the mixing apparatus, the size of the infused product batch desired, and the desired ratio of product to infusion solution. In a preferred embodiment, the ratio of product to infusion solution is 1:3.

As an example of the processing step 10, in one embodiment of the present invention, raw products such as fresh apples are processed for infusion. A suitable apple peeling/coring/segmenting/slicing machine is manufactured by Atlas Pacific. In trial runs, apples were processed using a 2-segmenter/halver to approximately 0.130″ to 0.146″ and more preferably, 0.138″ using the 0.140 slice wheel. After slicing, the fresh cut apples were soaked in an anti-browning treatment solution, prepared by mixing 99.5 lbs of water with 0.5 lbs of Ascorbic Acid, until infusion. The 100-lb solution was sufficient to completely submerge approximately 50 lbs. of fresh cut apple slices in the solution at all times. In another embodiment, IQF fruit and vegetable products are processed for infusion. In several trial runs, IQF green beans, IQF carrot slices, and IQF pineapple tidbits were thawed to about 45° F. in an atmospheric tub. Hot water (1000-120° F.) was circulated in the bottom jacket of the tub for 30 to 45 minutes and the products were mixed every 5 minutes with hot water until the product reached the desired temperature.

Separate from the processing step 10, the infusion solution is prepared 20. In another preferred embodiment, steps 10 and 20 may be combined simultaneously, thawing out IQF products by soaking them in the infusion solution maintained between approximately 40° F. to 55° F., and more preferably 45° F. to 50° F. As used herein, an infusion solution means a solution comprising about 30% to 60% solids by weight, and more preferably about 45% solids, where the solids are made up entirely or partially of a prebiotic soluble fiber other than inulin, such as scFOS or dextrin. The concentration of the prebiotic soluble fiber in the solution ranges from approximately 5% to 100% of the total solids, i.e. 100% of the solids can be fiber or fiber solids can be combined with other solids such as rice syrup solids. Other ingredients with beneficial nutrients (such as vitamins and minerals) can be added to the soluble fiber infusion solution for infusion into the fruit or vegetable. The infusion solution will contain between about 5% to 60% by weight soluble fiber. In one preferred embodiment, rood products are infused with either short chain fructooligosaccharides or dextrin alone. In another embodiment, the infused solution comprises the soluble fiber as well as rice syrup or corn syrup. The following working examples shown in Table 1 are provided as a reference and the approximate amounts should not be construed as limitations.

TABLE 1

| Raw Food | | Clarified | |
|---|---|---|---|
| Product | Soluble Fiber | Rice Syrup | Water |
| (fresh/frozen) | Powder (lbs) | (lbs) | (lbs) |
| Fresh | 43 | 416 | 366 |
| Fresh | 172 | 261 | 392 |
| Fresh | 391 | 0 | 434 |
| Frozen | 516 | 0 | 309 |

For example, the infusion solution to be used for IQF products is prepared 20 by blending 516 lbs. of short chain fructooligosaccharide syrup with 309 lbs. of water together in the infuser with a paint mixing drill for 2 to 3 minutes and then rotating the infusing vessel for 5 minutes to ensure uniform mixing, resulting in an infusion solution of 45% short chain fructooligosaccharide solids. In trial runs, 391 lbs. of either infusion solution was mixed with 434 lbs. of water to successfully infuse Empire variety apples with short chain fructooligosaccharide solution and Fuji variety apples with dextrin solution.

Thereafter, the prepped food products are combined with the infusion solution 30 in any convenient manner. Sufficient amounts of the infusion solution are combined such that the admixed food products are completely immersed in the infusion solution. Complete immersion is desired to ensure that sufficient contact is maintained between the products and the infusion solution. The infusion solution temperature should be at temperatures between 40° F. to 55° F., and more preferably 45° F. to 50° F. to avoid microbial growth. The following working examples are provided in Table 2 as a reference and the amounts should not be construed as limitations.

TABLE 2

| | | | Infused product |
|---|---|---|---|
| | Amount of Raw | Infusion solution | weight for |
| Food Product | Product (lbs) | weight (lbs) | frying (lbs) |
| Raw apples | 325 | 825 | 266 |
| IQF Green beans | 240 | 825 | 220 |
| IQF Pineapple | 360 | 825 | 220 |

For example, 325 lbs. of raw fresh apples cored, segmented and sliced, result in 275 lbs. of raw slices for infusion in 825 lbs. of infusion solution. Subsequent infusion results in 266 lbs. of infused food products.

The infusion solution preferably has an initial Brix concentration of about 40° to about 50°, preferably about 45°, as measured on the Brix scale. The Brix scale refers to a hydrometer scale used for sugar solutions that is graduated so its readings in degrees represent percentages by weight of sugar or solids in a solution at a specified temperature. Thus, Brix refers to a concentration of sugar or solids in a solution by weight. The initial Brix of the food product depends on the type of fruit or vegetable to be used, but they are typically less than about 16° Brix. The solution is maintained at a concentration of between about 30® to about 60° Brix. In a preferred method, the food products are first infused at atmospheric pressure 40, approximately 760 torr (1 atm), for 30 minutes to 60 minutes. The times will vary depending on the specific product and the desired end product attributes. Upon immersion in the infusion solution, the product begins to take in solids. The structural integrity of the product is reinforced as it is filled with solids from the infusion solution, to avoid collapse during frying in further operations. Infusion process conditions are typically driven by the physical properties of the fruit or vegetable piece being infused, such as the dimensions and uniformity of the food product, and the finished product quality desired, such as texture, flavor, appearance, and oil content. For examples, apple slices used in this invention are uniformly thin and hence need shorter infusion time (to achieve similar levels of solids addition) than green beans which are less uniform and thicker.

After the infusion phase at atmospheric pressure, the food products, in a preferred embodiment, will undergo vacuum infusion 50. It is preferred to subject the products to reduced pressure after a period of atmospheric infusion to allow the pieces to build structure and prevent damage to the products' cell walls when the vacuum is applied. When used in conjunction, the atmospheric and vacuum infusion methods maximize the efficiency of the infusion process. Vacuum infusion helps accelerate the mass transfer of solids into the product and significantly reduces the time required for infusion compared to atmospheric infusion. It also tends to maintain the shape of a product better, especially when combined with vacuum frying in the final stage. It is desirable to be able to conduct both infusion methods, either in conjunction or alone, within a single apparatus and customize the times to be used for each method and pressure levels for the vacuum infusion period to achieve the desired product characteristics. In an alternative embodiment, the vacuum infusion step 50 is not used.

Upon depressurization (vacuum creation), gas and moisture contained between the cell walls of the product is evacuated. When the vacuum is released, re-pressurization causes the infusion solution and thus its inherent solids to be forced into the spaces previously occupied by gas. In a preferred embodiment of the invention, pulses of vacuum are used to further accelerate the solute intake. A pulse of vacuum comprises depressurizing the apparatus for a short period of time and then re-pressurizing. Each of these cycles of depressurization (vacuum) and pressurization promote more efficient infusion, resulting in less infusion time.

The number of cycles and how long each product spends at the lower or elevated pressure is product dependent. Some products only require one cycle, while with other products it is desirable to have multiple cycles of depressurization and pressurization. Preferably, each pulse of vacuum is typically maintained for 2 to 5 minutes and applying at least one to two pulses of vacuum results in the most efficient product infusion. For example, in fresh apples and IQF green beans, the depressurization (vacuum) phase lasts from about 1 to 3 minutes, more preferably about 2 minutes. The subsequent re-pressurization lasts approximately 4 to 6 minutes, and more preferably 5 minutes, followed by subsequent depressurization from about 1 to 3 minutes, more preferably about 2 minutes. IQF pineapple is infused in three phases—first at atmospheric pressure for 50 to 70 minutes, preferably 60 minutes, then under vacuum (depressurized) for about 1 to 3 minutes, more preferably about 2 minutes, then concluded by a second atmospheric pressure phase for approximately 40 to 50 minutes, and more preferably 45 minutes.

In a preferred embodiment, vacuum infusion 50 is carried out by subjecting the products in the infusion solution to reduced pressure (partial vacuum) of about 200 torr to about 600 torr, as needed and customized for the product being infused for a period of up to ten minutes. For apple and similar fruits and frozen or thawed carrot slices, it is preferred that the depressurization (vacuum) pressure range from about 200 to about 400 torr. For frozen and thawed pineapple and whole green beans, it is preferred that the depressurization pressure range from about 200 to about 600 torr. These pressures are, however, provided for the purpose of illustration and are not limitations. The residence time and pressures involved in the vacuum pulses can vary significantly depending on the product and desired end product.

Once infusion is complete, the infusion solution along with the infused fruit or vegetable pieces is transferred onto a perforated conveyor which separates the infused fruit or vegetable material from the used infusion solution. The solution is collected below the conveyor and conveyed to a collection tank where it is re-concentrated to the desired solids level and reused to infuse further batches of fruit or vegetable material. Meanwhile, the infused fruit or vegetable material is transferred 60 into a frying basket, coated with a non-stick material such as Teflon. In a preferred embodiment, the infused material is allowed to drain approximately an additional 5 to 45 minutes in the fryer basket or on the conveyor prior to being loaded into the fryer basket and the drained solution is subsequently removed.

The product then undergoes vacuum frying 70 to achieve a rapid rate of water removal wherein the food material is deep-fried in oil at a temperature much lower than conventional frying methods. In a preferred embodiment, the product is fried at temperatures ranging between approximately 250° F. and 270° F. for approximately 10 to 50 minutes, with steam being supplied for about the initial 1 to 5 minutes so that the temperature of the frying oil can be maintained at a desired level such that the high moisture fruit or vegetable material being fried can be dehydrated effectively. Frying is done at a pressure of approximately 10 to 40 torr at different initial temperatures depending on the product in order to avoid browning. For apples, the preferred temperature is between approximately 250° F. and 265° F. with 2 to 4 minutes of steam for a frying time of approximately 12-14 minutes, and more preferably approximately 13 to 113.5 minutes, at a pressure of approximately 20 to 40 torr, and more preferably 30 torr. For green beans, the temperature is between approximately 230° F. and 270°, and more preferably 250° F. at a pressure between 20 and 40 torr, and more preferably 30 torr, with about 3 minutes of steam, for between approximately 20 to 30 minutes frying time, and more preferably 25 minutes, following by a drain time of about 3 minutes. For pineapples, the temperature is also between approximately 230° F. and 270° F., and more preferably 253° F. at a pressure between 20 and 40 torr, and more preferably 30 torr, with about 3 minutes of steam, for between approximately 40 to 55 minutes, and more preferably 47 minutes, followed by a drain time of about 3 minutes. End products infused with the soluble fiber infusion solution comprising dextrin result in flat shapes, while those infused with an infusion solution comprising short chain fructooligosaccharide result in more chip like, curly shapes. The flat shape of the infused dextrin product provides for easier draining of oil post-frying potentially leading to lower oil contents. In addition the shape provides for easier packaging. In an optional seasoning step, the products then undergo seasoning by any means known in the art such as application of a seasoning spray, powder, or slurry.

The products are then packaged 80 for consumer consumption. The finished infused food product will contain approximately 10% to 40% infused solids (soluble fiber) by weight. Water activity is reduced to about 0.1 to 0.15 in the finished product with a moisture content of 0.01 to 0.15. Oil in the finished product will vary depending on the food product. In a preferred embodiment, oil ranges from about 19% to about 32% by weight. Depending on the food product used, about 9 to 12 grams per fiber per ounce will also be part of the finished infused food product of which 8 to 10 grams is fiber (fructooligosaccharides) added through infusion. Working examples are provided in Table 3 below as a reference. The amounts should not be construed as limitations.

TABLE 3

| | % Oil | % Infused Solids |
|---|---|---|
| Finished Product | (approximate) | (approximate) |
| Infused Apple Chips | 21 | 32 |
| Infused Whole Green Beans | 25 | 30 |
| (seasoned) | | |
| Infused Carrot Chips | 23 | 31 |
| (seasoned) | | |
| Infused Pineapple Tidbits | 19 | 20 |

The aforementioned method and solute results in fried fruit and vegetable products infused with a soluble fiber, which provide enhanced natural flavor and an excellent source of fiber. While the invention has been particularly shown and described with reference to a preferred embodiment, it will be understood by those skilled in the art that various changes in form and detail may be made therein without departing from the spirit and scope of the invention.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

What is claimed is:

1. A method for infusing food products with an infusion solution, said method comprising the steps of:
a) preparing said food products for infusion; and
b) infusing said food products with an infusion solution comprising soluble fiber.

2. The method of claim 1 wherein said soluble fiber is in liquid form.

3. The method of claim 1 wherein said soluble fiber is in solid form.

4. The method of claim 1 further comprising the step of:
c) maintaining said infusion solution at a constant temperature of approximately 45° F. to 50° F.

5. The method of claim 4 further comprising the step of:
d) varying the pressure of said food products in said infusion solution for varying times.

6. The method of claim 5 further comprising the step of:
e) separating said food products from said infusion solution.

7. The method of claim 6 further comprising the step of:
f) vacuum-frying said infused food products.

8. The method of claim 7 further comprising the step of:
g) seasoning said food products.

9. The method of claim 7 further comprising the step of:
g) packaging said food products for consumer consumption.

10. The method of claim 1 wherein said food products comprises a fruit or vegetable.

11. The method of claim 1 wherein said food products are fresh products.

12. The method of claim 11 wherein said preparing of step a) comprises peeling, coring, pitting, segmenting, and slicing said food products.

13. The method of claim 1 wherein said food products are individually quick frozen products.

14. The method of claim 13 wherein said steps a) and b) are simultaneously performed.

15. The method of claim 13 wherein said preparing of step a) comprises thawing said food products.

16. The method of claim 5 wherein said varying the pressure of step d) comprises decreasing the pressure to between about 200 to 600 torr and increasing the pressure to about 760 torr.

17. The method of claim 5 wherein said varying the pressure of step d) further comprises at least one pulse of vacuum.

18. The method of claim 1 wherein said infusion solution is maintained at a concentration of between about 30° to about 60® Brix.

19. The method of claim 1 wherein said soluble fiber is a short chain fructooligosaccharide.

20. The method of claim 1 wherein said soluble fiber is a dextrin.

21. The method of claim 1 wherein said infusion solution comprises between about 5% to 60% by weight soluble fiber.

22. The method of claim 1 wherein said infusion solution comprises a soluble fiber combined with rice syrup.

23. The method of claim 1 wherein said infusion solution comprises a soluble fiber combined with corn syrup.

24. An infused food product made from the method of claim 1.

25. An infused food product comprising:
i. A soluble fiber concentration of up to approximately 10% to 40% by weight;
ii. Approximately 19% to 32% oil by weight;
iii. 9 to 12 grams of fiber per ounce; and
iv. Less than 2% moisture by weight.

26. The infused food product of claim 25 wherein said food product comprises a fruit or vegetable.

27. The infused food product of claim 25 wherein said soluble fiber is a short chain fructooligosaccharide.

28. The infused food product of claim 25 wherein said soluble fiber is a dextrin.

29. A food infusion solution comprising:
i. 45% solids by weight; and
ii. a prebiotic soluble fiber ingredient.

30. The solution of claim 29 wherein said prebiotic soluble fiber ingredient is approximately 5% to 100% of the total solids.

31. The solution of claim 29 wherein said soluble fiber is a short chain fructooligosaccharide.

32. The solution of claim 29 wherein said soluble fiber is a dextrin.

33. The solution of claim 29 wherein said solution also comprises rice syrup.

34. The solution of claim 29 wherein said solution also comprises corn syrup.

35. The solution of claim 29 wherein said solution also comprises vitamins.
